(19) United States
(12) Patent Application Publication
(10) Pub. No.: US 2008/0160190 A1
(43) Pub. Date: Jul. 3, 2008

(54) Method of fabricating nano structure, method of manufacturing magnetic disc, method of forming stamper, and method of generating base body

(75) Inventors: Mitsuo Takeuchi, Kawasaki (JP); Hiroaki Tamura, Kawasaki (JP); Ken-ichi Itoh, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/974,112

(22) Filed: Oct. 11, 2007

(30) Foreign Application Priority Data
Dec. 27, 2006 (JP) 2006-350835

(51) Int. Cl. B05D 1/36; B05D 5/00

(52) U.S. Cl. 427/203; 427/180

(57) ABSTRACT

A method of fabricating a nano structure includes the steps of: forming a particle layer on a substrate that is nano-scale flat by spreading at least one layer of nano-sized particles made of a material different from that of the substrate; forming a holder on the particle layer that holds the particle layer by closely adhering to the particles forming the particle layer; and removing the substrate in a manner that leaves the particle layer intact.

### BACKGROUND OF THE INVENTION

1. Field of the Invention

The present invention relates to a method of fabricating a nano structure for creating a nano-sized concave and convex structure (nano structure), a method of manufacturing a magnetic disc for producing a magnetic disc by using such a nano structure, a method of forming a stamper as an imprint mold having the nano structure, and a method of generating a base body in which the nano structure is formed on a predetermined base material.

2. Description of the Related Art

In the field of computer, high volumes of data is handled on a daily basis and a Hard Disk Drive (HDD) is used as one device for recording and reproducing such large volume data. This HDD incorporates a magnetic disc in a disc shape as a magnetic recording medium in which data is recorded and a magnetic head for recording data onto and reproducing data from this magnetic disc.

Conventionally, a type of magnetic discs made of a uniform magnetic material is known, but this type of magnetic discs is close to its limit where recording density of data is concerned. Therefore, as one example of a magnetic disc with higher recording density, a type of magnetic disc called patterned media, which will be described later, has been proposed.

FIG. 1 is a schematic diagram illustrating a magnetic disc and a magnetic head of the patterned media type.

As shown in this FIG. 1, a magnetic disc 11 of the patterned media type has multiple microscopic regions (1 bit region) 11a where magnetization equivalent to 1 bit is held individually to each other. In this example of FIG. 1, microscopic holes are formed by piercing through a disc made of a nonmagnetic material such as aluminum and then are filled with a magnetic material, so that each 1 bit region 11a is obtained. This magnetic disc 11 includes nonmagnetic material between the 1 bit regions 11a. Thus, it is possible to avoid problems likely in recording data with high recording density, such as mutual interference of magnetization between these 1 bit regions 11a.

Further, the magnetic head is disposed in the close proximity of the magnetic disc 11 by an arm 12 mounted with the magnetic head. At the time of recording data, the magnetic head generates a magnetic field in accordance with a signal current from outside, and records 1 bit data by means of a magnetization direction in the 1 bit region 11a, by appropriately inverting the magnetization of each 1 bit region 11a on the surface of the magnetic disc. Furthermore, at the time of reproducing data, the magnetic head reproduces the 1 bit data by means of magnetization direction in the 1 bit region 11a by detecting a leakage field radiated from the magnetization of each 1 bit region 11a.

Here, with this magnetic disc 11 of the patterned media type, in order to realize a recording density exceeding a recording density in the magnetic disc type made of a uniform magnetic material, an array pattern of the 1 bit regions 11a needs to be reduced to nano size, as shown in FIG. 1, by making diameter of each 1 bit region 11a from 1 to 100 nm and array spacing from 10 to 100 nm or the like. Recently, as precision processing technique has advanced to become available for a nano-sized structure beyond a micro-sized structure, manufacturing of magnetic discs of such a patterned media type has been made possible.

As examples of methods for a nano-sized precision processing, there are known one that adds a physical strength to the target object by a micro needle or the like and one that utilizes photolithography or electron beam lithography, etc. widely used for the production of semiconductor devices. While these methods have a merit in that the nano-sized precision processing can be done precisely, they require many process steps and an area that can be processed at a time is narrow. Thus, these methods requires enormous amount of time for arranging microscopic holes equivalent to the 1 bit region over a wide area corresponding to the magnetic disc. Therefore, these methods have a problem that they are not suitable for mass production of products such as magnetic discs that require precision processing over such a wide area like this.

Here, to achieve simplification of processing in the lithography technique, the following method has been proposed that omits labor of forming a mask corresponding to the 1 bit array pattern in the magnetic disc on the target surface. In this technique, processing is simplified by arranging nano-sized microscopic particles (nanoparticles) having a sphere shape or the like, with a diameter of 1 to 100 nm for example, made of a metal or a resin, etc. The nano particles are arrayed on the target surface by an array method that utilizes so-called self-assembly phenomenon, and the arrayed particles are used as a mask of lithography (see Japanese Patent Laid-open Nos. 2005-217390 and 2005-339633, for example). However, with such a method, nanoparticles need to be spread over the target surface each time of the processing so that still too much labor is required for mass production of magnetic discs.

Therefore, for example, as a method of easily processing an array pattern of holes or the like corresponding to the 1 bit region on the target surface, a technique has been proposed in which an imprint mold (stamper) corresponding to such an array pattern is prefabricated by the lithography or the like and at the time of processing the target surface, the array pattern is imprinted by pressing the stamper against the target surface (see Japanese Patent Laid-open No. 2004-314238, for example).

This technique may be suitable for mass production, because multiple target surfaces can be processed by using one stamper repeatedly. However, since this stamper is consumables and wears and tears each time it is used, it needs to be created in multiple numbers, for mass production of magnetic discs. But creating this stamper by the lithography, etc. as described above requires too much labor in the end.

By the way, a technique has been proposed in which an array pattern for a model of a stamper is easily created by arranging nanoparticles with an array method utilizing the self-assembly phenomenon of microscopic particles that spontaneously creates a regular structure basically without a control from outside (see Japanese Patent Laid-open No. 2005-76117, for example). The stamper can be obtained by transferring the created array pattern.

Among the array methods of nanoparticles utilizing this self-assembly phenomenon, there are a variety of methods such as the one disclosed in this Japanese Patent Laid-open No. 2005-76117 in which a suspension of microscopic particles is dripped adequately onto a substrate and dried to cause the self-assembly phenomenon of the microscopic particles in the suspension, so that the microscopic particles are arranged on the substrate. Hereinafter, as one example of the array methods for arranging nanoparticles utilizing such self-assembly phenomenon, so called a flow-mediated aggregate method that is handy with less process steps is explained.

FIG. 2 is a schematic diagram illustrating a typical example of an array method of nanoparticles by the flow-mediated aggregate method.

The flow-mediated aggregate method in the array method shown in this FIG. 2 utilizes the self-assembly phenomenon of nanoparticles 14. When a substrate 13 is pulled up in the direction indicated by an arrow A in FIG. 2 at a super slow speed of about several μm per second, the nanoparticles 14 deposit themselves spontaneously in a dense structure at the boundary of air-liquid on the surface of the substrate 13 that has been immersed vertically in a suspension 15 of the nanoparticles 14. Like this, a stamper can be easily created by transferring the array of the nanoparticles 14 thus arranged on the surface of the substrate 13.

If such a technique is applicable for the technique in Japanese Patent Laid-open No. 2004-314238, labor of creating a stamper can be reduced and mass production of the magnetic discs or the like can become practical.

Here, while the array method according to the flow-mediated aggregate method is handy with much less process steps, requiring only a step of pulling up the substrate 13 from the suspension 15 of the nanoparticles 14, it has the following problem.

FIG. 3 is a schematic diagram illustrating the problem of the array method according to the flow-mediated aggregate method.

The self-assembly phenomenon in this flow-mediated aggregate method is very unstable as it is susceptible to the surrounding environments such as a temperature and moisture in the surrounding and the liquid environments such as a temperature of the suspension. Because of this, if there is even a slight fluctuation in the surrounding environments or in the liquid environments while pulling up the substrate 13, an array of the nanoparticles 14 arranged by using the flow-mediated aggregate method is affected by the fluctuation and as shown in Part (a) and Part (b) of this FIG. 3, the number of layers on the substrate 13 is changed while pulling up the substrate 13. Part (a) of FIG. 3 shows an example of the nanoparticles 14 partially becoming in three layers while being arranged in two layers, and Part (b) of FIG. 3 shows an example of the nanoparticles 14 partially becoming in five layers while being arranged in four layers.

As shown in this FIG. 3, if a disordered array pattern in which the number of layers partially increases is transferred to a stamper as it is, the array pattern to be imprinted by using the stamper naturally becomes disordered. Because of this, the surrounding environments and the liquid environments need to be controlled very tightly in the event of arranging the nanoparticles by using the flow-mediated aggregate method. Such tight control may be possible if the area for arranging the nanoparticles is narrow, but it is almost impossible if the nanoparticles are arranged in a wide area such as the whole surface of the magnetic disc 11, so that mass production of the magnetic disc 11 with the use of the array method of the nanoparticles by the flow-mediated aggregate method is now almost impractical. For this reason, a method is desired that is capable of easily obtaining an array pattern of the nanoparticles over such a wide area, and a nano structure over a wide area such as a nano-sized concave and convex structure in the stamper to which such an array pattern is transferred.

So far, by citing examples of manufacturing magnetic discs, the explanation has been given for circumstances in which a method capable of obtaining a nano structure easily is desired for manufacturing of the magnetic discs. Such circumstances is not limited to the manufacturing of the magnetic discs, but may arise in general in the production of anything that requires a nano structure, for example, such as patterned media other than the magnetic disc, a light guide board having a nonreflective feature with a nano-sized dense concave and convex structure to be used for a display or the like of mobile phones, or a high efficiency filter or the like having nano-sized dense holes.

### SUMMARY OF THE INVENTION

The present invention has been made in view of the above circumstances and provides a method of fabricating a nano structure capable of obtaining a nano structure easily over a wide area, a method of manufacturing a magnetic disc for producing a magnetic disc by using such a nano structure, a method of forming a stamper having the nano structure, and a method of generating a base body having the nano structure.

A method of fabricating a nano structure according to the present invention includes the steps of:

forming a particle layer on a substrate that is nano-scale flat by spreading at least one layer of nano-sized particles made of a material different from that of the substrate;

forming a holder on the particle layer, the holder holding the particle layer by closely adhering to particles forming the particle layer; and

removing the substrate in a manner that leaves the particle layer intact.

According to this method of fabricating a nano structure of the present invention, an array of particles in the particle layer at the substrate side can be obtained as a nano structure. At this substrate side, the particles are precisely aligned along the substrate. Because of this, even if there is a disorder in the array of particles on the surface opposite to the substrate side in the particle layer when the particle layer is formed over a wide area by the flow-mediated aggregate method, a uniform nano structure along the substrate can be obtained over the wide area. Therefore, according to the method of fabricating a nano structure of the present invention, excessively strict control of the surrounding environments becomes unnecessary in the formation of the particle layer utilizing the flow-mediated aggregate method or the like, and a nano structure over the wide area can be easily obtained.

Here, in the method of fabricating a nano structure of the present invention, the step of forming a particle layer may be “a step of forming the particle layer by immersing the substrate into a suspension of the particles and by pulling up the substrate from the suspension.”

According to the method of fabricating a nano structure in this preferred embodiment, particles can be easily spread on the substrate by the flow-mediated aggregate method utilizing the self-assembly phenomenon in which the particles deposit themselves spontaneously on the substrate in a dense structure at the boundary of air-liquid when the substrate is pulled up from the suspension.

Furthermore, in the method of fabricating a nano structure of the present invention, preferably “the substrate is made of resin and the particles are made of silica, and the step of removing the substrate is a step that removes the substrate by burning the substrate”; “a substrate made of glass as the substrate and uses particles made of resin as the particles, and the step of removing the substrate is a step that dissolves the substrate by using a predetermined solvent”; or “the substrate is made of glass and the particles are made of resin, and the step of removing the substrate is a step that removes the substrate by dissolving in dilute hydrofluoric acid (HF) solution.”

According to the method of fabricating a nano structure in these preferred embodiments, the substrate can be certainly removed by leaving the particle layer. Here, as a method of burning an object by suppressing physical impact on the surrounding noncombustibles to nano level, a method or the like that uses an apparatus called plasma asher is known, which burns organic substances by exposing the targeted organic substances, etc. to oxygen plasma or the like under high temperature. Moreover, particles arranged by utilizing for example, the self-assembly phenomenon has been known to bond to each other securely with a certain degree of strength, so that the substrate can be dissolved in the solvent or in the dilute HF solution without disrupting the array of the particles.

Moreover, in the method of fabricating a nano structure of the present invention, preferably “the step of forming a holder is a step of forming a metal layer on the particle layer and adheres a block body onto the metal layer.”

According to the method of fabricating a nano structure in this preferred embodiment, easy handling such as carrying the block body is made possible for the particle layer.

Still more, the method of fabricating a nano structure of the present invention may include “the step of fixing an array of particles by forming a metal layer on a surface of the particle layer, the surface of the particle layer being exposed by removing the substrate in the step of removing the substrate.”

The above feature avoids disruption of the array of particles by an external force or the like surpassing the bonding by the self-assembly phenomenon. Eventually, the array of particles can be easily utilized for manufacturing products, etc.

Further, the method of fabricating a nano structure of the present invention may include “the step of fixing an array of particles by forming a metal layer on a surface of the particle layer, the surface of the particle layer being exposed by removing the substrate in the step of removing the substrate, the metal layer so thin that the array of particles on the surface of the particle layer stands out from a back of the metal layer.”

Such a feature enables mass production of a stamper by saving the fixed array of particles for example, as a master of an imprint mold (stamper) of the nano structure and by transferring the array of particles.

Additionally, the method of fabricating a nano structure of the present invention may include “the step of creating a mold by transferring an array of particles on a surface of the particle layer, the surface of the particle layer being exposed by removing the substrate in the step of removing the substrate.”

Accordingly, such operation as mass production of a stamper is made possible by using the mold to which the array of particles has been transferred as a master of the stamper.

In addition, in the method of fabricating a nano structure of the present invention, preferably the step of forming a particle layer is a step of forming a particle layer by spreading the particles in a plurality of layers, and

the step of forming a holder is a step of forming a first metal layer on the particle layer and adhering a first block body onto the first metal layer,

the method further comprising the step of creating a mold to which the array of particles is transferred,

wherein the step of creating the mold includes:

fixing an array of particles by forming a second metal layer on a surface of the particle layer, the surface of the particle layer being exposed by removing the substrate in the step of removing the substrate;

adhering a second block body onto the second metal layer;

separating the first block body and the second block body from each other at the particle layer by applying force to the first block body and the second block body; and

removing particles attached to the second block body by the separation, from among the particles forming the particle layer, in a manner that leaves the second metal layer intact.

According to the method of fabricating a nano structure in this preferred embodiment, the mold is created by transferring the array of particles as a shape of a solid substance of a metal film. And such operation as mass production of a stamper is made possible by using such a robust mold as a master of the stamper.

Furthermore, a method of manufacturing a magnetic disc of the present invention includes the steps of:

forming a particle layer on a substrate that is nano-scale flat by spreading at least one layer of nano-sized particles made of a material different from that of the substrate;

forming a holder on the particle layer, the holder holding the particle layer by closely adhering to the particles forming the particle layer; and

removing the substrate in a manner that leaves the particle layer intact;

creating a mold by transferring an array of particles on a surface of the particle layer, the surface of the particle layer being exposed by removing the substrate in the step of removing the substrate;

forming a plurality of holes with an array that is the same as the array of particles, on a disc made of a nonmagnetic material by using the mold created in the step of creating a mold; and

filling with a magnetic metal each of the plurality of holes formed in the step of forming holes.

According to this method of manufacturing a magnetic disc of the present invention, by using the mold as a master of the stamper, a nano structure having the array pattern of plural holes on the disc can be easily created. And by filling the magnetic metal into these holes, microscopic regions for holding magnetization are formed and a magnetic disc is completed. Like this, by using the mold, the magnetic disc can be created with less process steps and little labor. In addition, according to the method of manufacturing a magnetic disc of the present invention, the mold itself can be easily obtained so that mass production of the magnetic disc is made possible with less process steps and little labor.

Moreover, a method of forming a stamper includes the steps of:

immersing a substrate into a suspension of microscopic particles;

pulling up the substrate from the suspension;

forming a first layer on a particle layer formed of the microscopic particles that is formed on the substrate pulled up from the suspension;

separating the particle layer and the first layer from the substrate;

forming a second layer on a surface of the particle layer, the surface having contacted the substrate before the separation;

separating the particle layer and the first layer from the second layer; and

forming a stamper by using the second layer as a mold.

According to this method of forming a stamper of the present invention, the stamper can be easily formed by using the mold as a master of the stamper. In addition, according to this method of forming a stamper of the present invention, the mold itself can be easily obtained so that mass production of the stamper is made possible with less process steps and little labor.

Furthermore, a method of generating a base body of the present invention includes the steps of:

immersing a substrate into a suspension of microscopic particles;

pulling up the substrate from the suspension;

forming a first layer on a particle layer formed of the microscopic particles that is formed on the substrate pulled up from the suspension;

separating the particle layer and the first layer from the substrate;

forming a second layer on a surface of the particle layer, the surface having contacted the substrate before the separation;

separating the particle layer and the first layer from the second layer;

forming a stamper by using the second layer as a mold; and

generating a base body in which a pattern is formed by pressing the stamper against a base material.

According to this method of generating a base body of the present invention, by using the stamper, a nano structure having the array pattern of multiple holes can be easily created on a base material, for example, such as a disc for a magnetic disc, so that the base body for such magnetic disc can be created with less process steps and little labor. In addition, according to this method of generating a base body of the present invention, the stamper can be easily obtained so that mass production of the base body is made possible with less process steps and little labor.

Regarding the method of manufacturing a magnetic disc of the present invention, the method of forming a stamper of the present invention and the method of generating a base body of the present invention, here, the description is made only for basic embodiments thereof and specific embodiments to each method. However, this is intended simply for avoiding redundancy, and the method of manufacturing a magnetic disc of the present invention, the method of forming a stamper of the present invention and the method of generating a base body of the present invention do not only include the above-described embodiments, but also include various types of embodiments corresponding to each embodiment of the method of fabricating a nano structure of the present invention.

As explained above, according to the present invention, a method of fabricating a nano structure capable of obtaining a nano structure easily over a wide area, a method of manufacturing a magnetic disc for producing magnetic discs by using such a nano structure, a method of forming a stamper with the nano structure, and a method of generating a base body with the nano structure can be obtained.

### BRIEF DESCRIPTION OF THE DRAWINGS

FIG. 1 is a schematic diagram illustrating a magnetic disc and a magnetic head included in a hard disk drive (HDD).

FIG. 2 is a schematic diagram illustrating a typical example of the array methods of nanoparticles by a flow-mediated aggregate method.

FIG. 3 is a schematic diagram illustrating a problem of the array method according to the flow-mediated aggregate method.

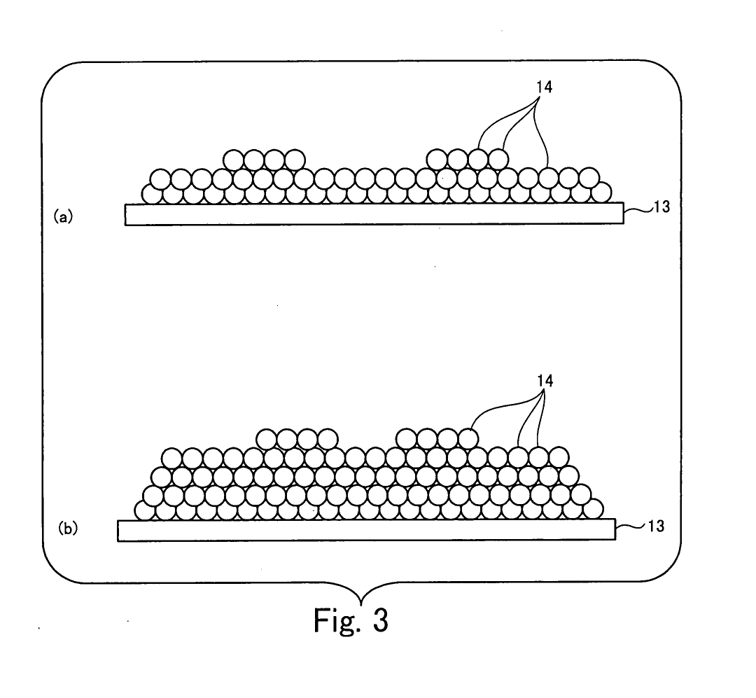

FIG. 4 is a flowchart illustrating a method of manufacturing a magnetic disc as one embodiment of the present invention.

FIG. 5 is a flowchart illustrating a step of preparing a stamper (step S100).

FIG. 6 is a schematic diagram illustrating a step of forming a particle layer executed in the step of preparing a stamper mold (step S110) shown in FIG. 5.

FIG. 7 is a diagram illustrating a flow of processing from when a layer of silica particles is formed on a resin substrate in the step of forming the particle layer (step S111) shown in FIG. 6 until when a stamper is obtained.

FIG. 8 is a typical example of images by an electron microscope obtained to confirm the uniformity of the array pattern of the silica particles obtained over a wide area.

FIG. 9 is a typical example of images by an electron microscope obtained to confirm the uniformity of the concave and convex pattern of a silicon film.

FIG. 10 is a diagram illustrating a step of manufacturing (step S200) in FIG. 4 in detail.

FIG. 11 is a diagram illustrating a step of fixing an array.

### DETAILED DESCRIPTION OF THE INVENTION

The embodiments of the present invention will be described below with reference to the accompanying drawings.

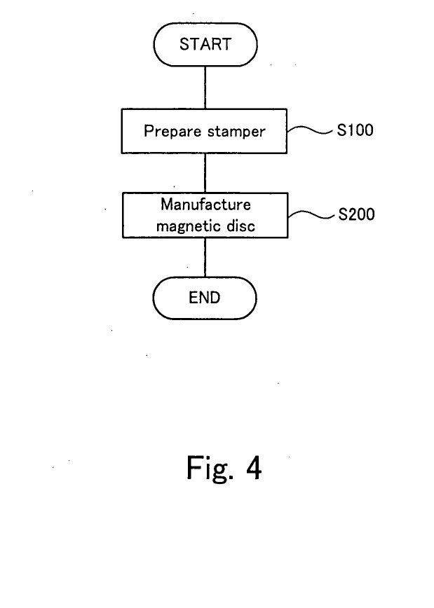

FIG. 4 is a flowchart illustrating a method of manufacturing a magnetic disc as one embodiment of the present invention.

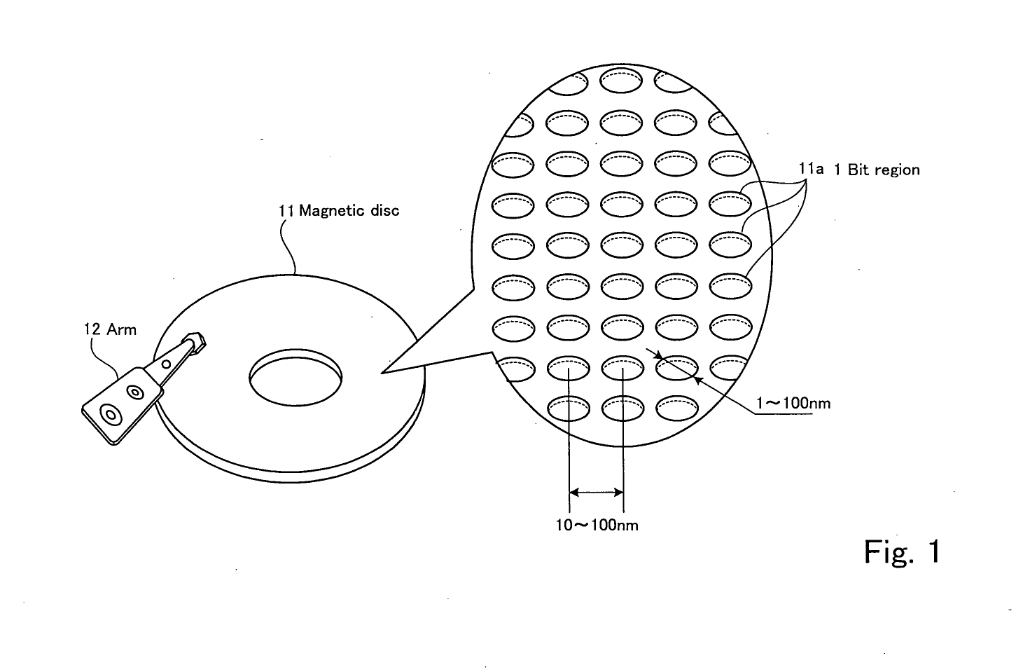

The method of manufacturing a magnetic disc illustrated in this FIG. 4 corresponds to one embodiment of the method of manufacturing a magnetic disc according to the present invention and is a method of manufacturing a magnetic disc 11 by forming multiple 1 bit regions 11a on a disc made of aluminum with a nano-sized array pattern as shown in FIG. 1, and includes the step of preparing a stamper (step S100) and the step of manufacturing (step S200).

As explained with reference to FIG. 1, each 1 bit region 11a is obtained by filling a microscopic hole pierced into a disc with a magnetic material. A step of preparing a stamper (step S100) is a step for creating an imprint mold (stamper) that is used in the following manufacturing step (step S200) to imprint concaves (hollows), which are formed into the microscopic holes with a nano-sized array pattern, on an aluminum substrate. This step of preparing a stamper (step S100) corresponds to one embodiment of the method of forming a stamper according to the present invention.

Firstly, this step of preparing a stamper (step S100) is explained in detail.

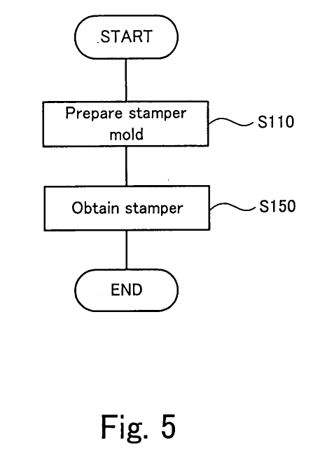

FIG. 5 is a flowchart showing the step of preparing a stamper (step S100) shown in FIG. 4.

As shown in this FIG. 5, the step of preparing a stamper (step S100) includes the step of preparing a stamper mold (step S110) and the step of obtaining a stamper (step S150).

The stamper obtained in the present embodiment is a metal board in which microscopic convex sections are arranged uniformly with a nano-sized array pattern over a wide area corresponding to the surface of the magnetic disc 11. In the step of preparing a stamper (step S100), in order to create this stamper, first of all, a stamper mold as a mold having an array pattern of the concave sections corresponding to the array pattern of the convex sections for the wide area equivalent to the stamper is created in the step of preparing a stamper mold (step S110). Thereafter, in the step of obtaining a stamper (step S150) that follows this step of preparing a stamper mold (step S110), a stamper is created by using the stamper mold.

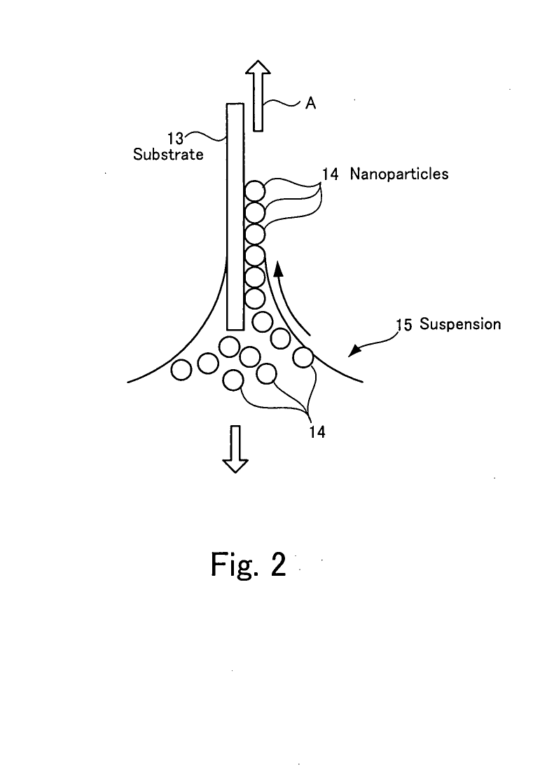

In the step of preparing a stamper mold (step S110), firstly, with the use of the array method of nanoparticles by the flow-mediated aggregate method explained with reference to FIG. 2, a step of forming a particle layer is executed in which a particle layer is formed having nanoparticles spread in multiple layers on the wide surface of the substrate corresponding to the surface of the magnetic disc 11.

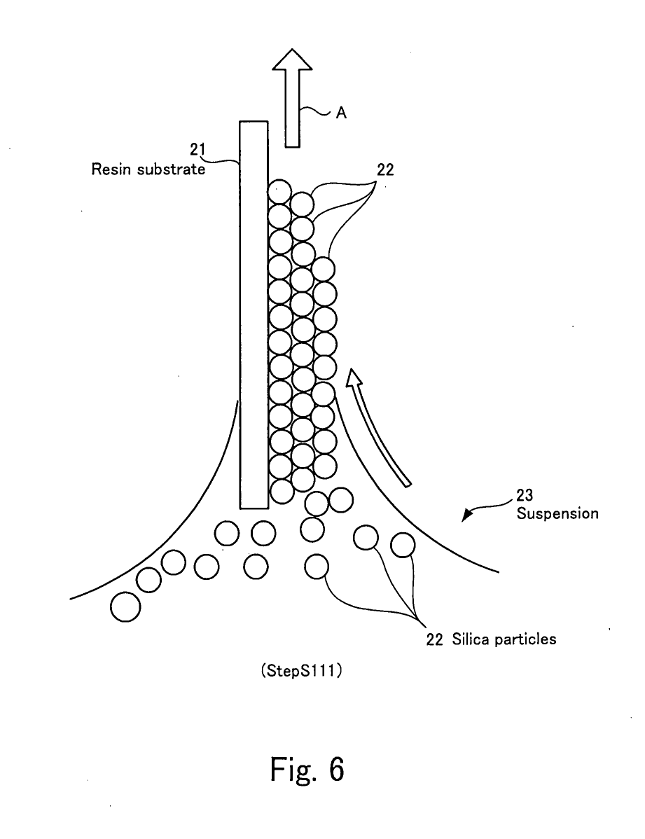

FIG. 6 is a schematic diagram illustrating the step of forming a particle layer executed in the step of preparing a stamper mold (step S110) shown in FIG. 5.

The step of forming a particle layer (step S111) shown in this FIG. 6 corresponds to one example of the step of forming a particle layer according to the present invention.

As described above, the array method of nanoparticles used in this step of forming a particle layer (step S111) uses the flow-mediated aggregate method. In FIG. 2, no specific type is specified for the nanoparticles and the substrate, however in this embodiment, a particle made of silica (silica particle) 22 having a sphere shape with a diameter of 1 to 100 nm is used as the nanoparticle, and a substrate made of resin (resin substrate) 21 having the thickness of several 10 μm is used as the substrate. In addition, in the present embodiment, at the time of pulling up the resin substrate 21 immersed in a suspension 23 of silica particles, the resin substrate 21 is pulled up in the direction indicated by an arrow A at such a speed that multiple layers of the silica particles 22 can be formed on the resin substrate 21.

Additionally, although in the present embodiment, an example that uses the silica particle 22 as the nanoparticle and the resin substrate 21 as the substrate is shown as described above, the present invention is not limited to this example. As another example of the present invention, a resin particle made of polystyrene or the like may be used as the nanoparticle and a glass substrate may be used as a board. In the following, further explanation is given by showing another example that uses the polystyrene particles and the glass substrate.

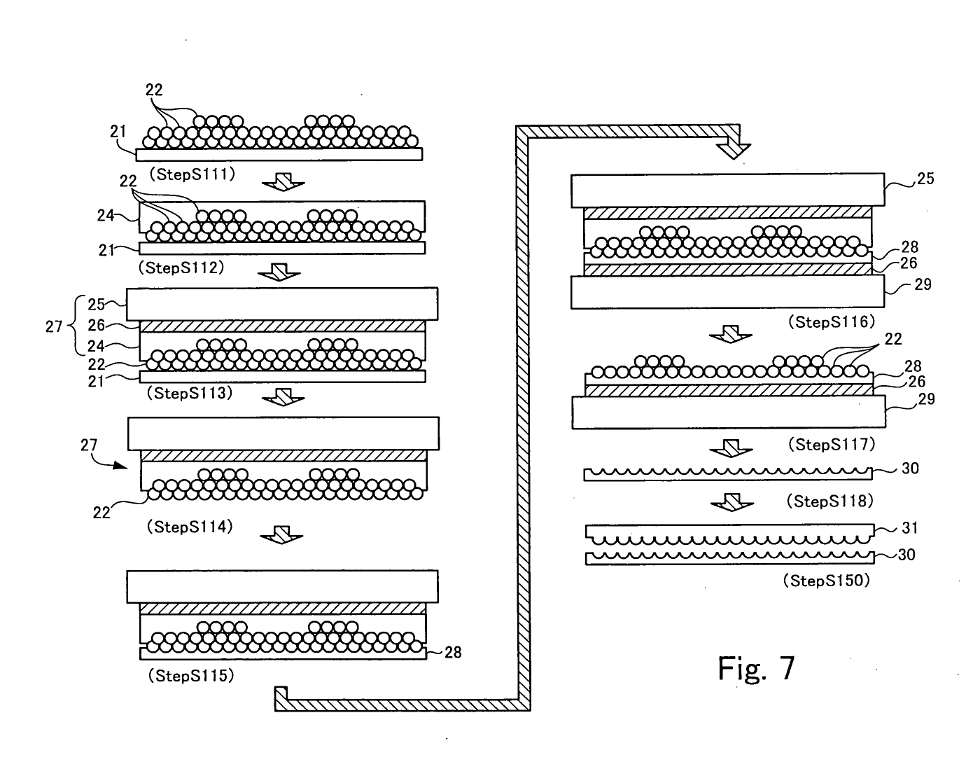

FIG. 7 is a diagram illustrating a flow of processing from when the layer of silica particles is formed on the resin substrate 21 in the step of forming a particle layer (step S111) shown in FIG. 6 until when a stamper is obtained.

In this FIG. 7, the step of forming a particle layer (step S111) in FIG. 6 is also described. Here, the array method using the flow-mediated aggregate method shown in FIG. 6 has a high possibility that the number of layers of the silica particles 22 on the resin substrate 21 changes while the resin substrate 21 is pulled up, due to an influence of subtle fluctuation in the surrounding environments and the liquid environments at the time of pulling up the resin substrate 21. FIG. 7 shows one example of the layer of the silica particles 22 formed on the resin substrate 21 by the step of forming a particle layer (step S111). A particle layer entirely having two layers and partially having three layers is illustrated.

The step of forming a particle layer (step S111) is followed by a step of forming a supporting film (step S112). In step S112, a supporting film 24 made of silicon and having the thickness of several hundreds nm is formed, by using a sputtering method, to be adhered to the surface of the particle layer on the resin substrate 21 and thereby to support the particle layer. After step S112, the step of adhering a block body (step S113) is executed in which a first block body 25 is adhered onto the formed supporting film 24 with an adhesive 26. With this, a holder 27 composed of the supporting film 24 and the first block body 25 is completed. Here, a combination of the step of forming a supporting film (step S112) and the step of adhering a block body (step S113) corresponds to one example of the step of forming a holder according to the present invention.

Next, in a step of removing the substrate (step S114), the resin substrate 21 is removed from laminated substances composed of the resin substrate 21, the layer of the silica particles 22 and the holder 27 in the following manner that leaves the layer of the silica particles 22 intact. In this step of removing the substrate (step S114), an apparatus called plasma asher is used to remove the resin substrate 21, which generates oxygen plasma of high temperature by plasmalizing reaction gas mainly composed of oxygen gas or the like and burns organic substances by putting the organic substances in the oxygen plasma. In the step of removing the substrate (step S114), by this plasma asher, only the resin substrate 21 is burned that is organic substances among the laminated substances. This step of removing the substrate (step S114) corresponds to one example of the step of removing the substrate according to the present invention. Here, burning an object by this plasma asher is known as the method of burning an object by suppressing physical impact on the surrounding noncombustibles to nano level. Thus, in this step of removing the substrate (step S114), the resin substrate 21 can be burned without disrupting the layer of the silica particles 22.

Incidentally, here, although burning by plasma asher is taken as an example of the methods of removing the resin substrate 21, the present invention is not limited to this method. For example, the resin substrate 21 may be dissolved by using an organic solvent such as toluene or xylene. Also in this method, the silica particles 22 that are inorganic substances still remain. Moreover, the silica particles 22 having been formed into the layer by the flow-mediated aggregate method are known to bond to each other securely with a certain degree of strength, even if the resin substrate 21 to which the layer of the silica particles 22 is attached is dissolved in an organic solvent. Accordingly, the layer of the silica particles 22 still remains without deformation.

Here, further explanation is given for another example that uses the polyethylene particles and the glass substrate. In this another example, similarly to the above example, after laminated substances composed of the glass substrate, the layer of the polyethylene particles and a supporting block of the particle layer equivalent to the holder 27 in FIG. 7 are formed, the glass substrate is removed. However in this another example, the glass substrate is dissolved by immersing the laminated substances into a solvent such as dilute hydrofluoric acid (HF) solution and then removed. Incidentally, also in this another example, because the polyethylene particles having formed a layer on the glass substrate bond to each other securely with a certain degree of strength, even if the glass substrate onto which the layer of the polyethylene particles is attached is dissolved in such a dilute HF solution, the layer of the polyethylene particles still remains without deformation.

Further, explanation continues on the present embodiment.

After the resin substrate 21 is removed by the step of removing the substrate (step S114), as shown in FIG. 7, a surface of the layer of the silica particles 22 (the surface attached onto the resin substrate 21 before the step S114 and now corresponding to the lowest layer) is exposed. On this surface of the layer of the silica particles 22, the silica particles 22 are precisely aligned along the resin substrate 21. Because of this, even though the number of layers is varied in the step of forming a particle layer (step S111) and disruptions are caused in the array pattern on a surface of the layer of the silica particles 22 opposite to the resin substrate 21 as shown in FIG. 7, the surface exposed by the step of removing the substrate (step S114) becomes an uniform array pattern in which the silica particles 22 are aligned densely over a wide area. This array pattern of the silica particles 22 corresponds to one example of a nano structure according to the present invention. Moreover, a series of processing starting from the step of forming a particle layer (step S111) to the step of removing the substrate (step S114) is regarded as one of the embodiments of the method of fabricating a nano structure according to the present invention.

Here, the inventors of the present invention have confirmed the uniformity of the array pattern of the silica particles 22 obtained over a wide area corresponding to a magnetic disc by taking photographs of twenty observation areas randomly selected within the areas by an electron microscope. In the following, one among the electron microscope images obtained by this photographing is displayed as a typical example.

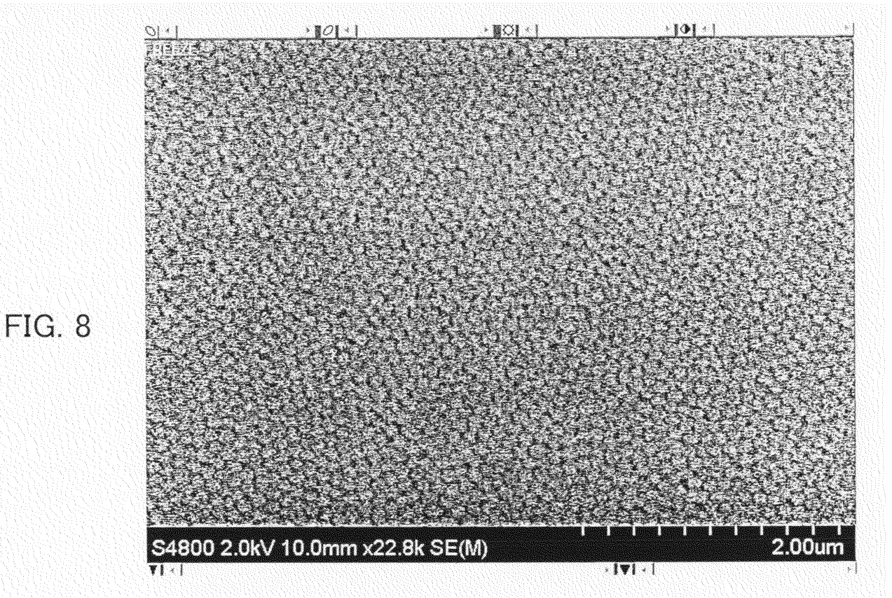

FIG. 8 is a typical example of the electron microscope images obtained to confirm the uniformity of the array pattern of the silica particles 22 obtained over a wide area.

The electron microscope image in this FIG. 8 shows that the silica particles 22 are densely arranged without disruption. Although presentation of another electron microscope images is omitted here, based on the ground that a dense array pattern of the silica particles 22 is confirmed in any of the electron microscope images, it can be considered that the array pattern of the silica particles 22 obtained in the step of removing the substrate (step S114) in FIG. 7 possesses an uniformity over a wide area corresponding to the magnetic disc.

After this kind of array pattern can be obtained, next, the step of forming a silicon film (step S115) that forms a silicon film 28 adhering closely to the array pattern by using the sputtering method is executed, followed by the step of adhering a block body for supporting the silicon film 28 (step S116) in which a second block body 29 supporting this silicon film 28 is adhered to the formed silicon film 28 with an adhesive 26.

Then, in a step of separation (step S117), force is applied to the first block body 25 and the second block body 29 in such a direction as to separate the first block body 25 from second block body 29. Specifically, in this step of separation (step S117), the laminated substances from the first block body 25 to the second block body 29 are separated at the silica particles 22 that are most brittle laminated layers. As a result, as shown in FIG. 7, the laminated substances in which a part of the silica particle layer 22 is attached to the silicon film 28 adhered to the second block body 29 can be obtained.

Subsequently, in a step of removing particles (step S118), the silica particles 22 attached to the silicon film 28 is removed by immersing the laminated substances with the second block body 29 obtained in the step of separation (step S117) into a solvent such as dilute HF solution. This step of removing particles (step S118) corresponds to one example in the step of removing particles according to the present invention. In step 118 of FIG. 7, a state just after this step of removing particles is illustrated by omitting the second block body 29 and the adhesive 26.

Here, explanation is given for another example that uses the polyethylene particles and the glass substrate. In this another example, after the silicon film is formed on the layer of the polyethylene particles, adhesion and separation of a block equivalent to the second block body 29 are executed in a manner similar to the above example, and substances in which polyethylene particles are attached onto the silicon film can be obtained. However, in this another example, layers of the polyethylene particles are removed by being burnt using the plasma asher, which is different from the above example.

Further, explanation continues on the present embodiment.

In the step of removing particles (step S118), a surface of the silicon film 28 opposite to the second block body 29 is exposed. This surface is the one that the uniform array pattern of the silica particles 22 over a wide area corresponding to a magnetic disc obtained in the step of removing the substrate (step S114) is transferred with the concave and convex pattern reversed.

Here, the inventor of the present invention has confirmed the uniformity of the concave and convex pattern of the silicon film 28 obtained over a wide area corresponding to a magnetic disc by taking photographs of twenty observation areas randomly selected within the areas by an electron microscope. In the following, one among the electron microscope images obtained by this photographing is displayed as a typical example.

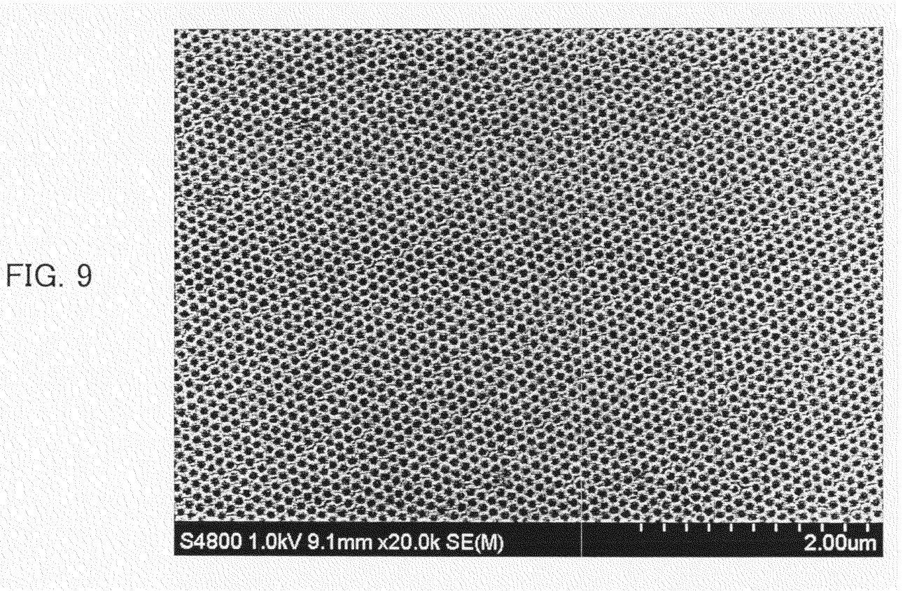

FIG. 9 is a typical example of the electron microscope images obtained to confirm the uniformity of the concave and convex pattern of the silicon film 28.

The electron microscope image in this FIG. 9 shows that a dense concave and convex pattern obtained by transferring the dense array pattern of the silica particles 22, such as the one shown in the electron microscope image in FIG. 8, on the surface of the silicon film 28 with its concave and convex reversed. Although presentation of another electron microscope images is omitted here, based on the ground that such a dense concave and convex pattern has been confirmed in any of the electron microscope images, it can be considered that the dense concave and convex pattern on the surface of the silicon film 28 obtained in the step of removing particles (step S118) in FIG. 7 possesses an uniformity over a wide area corresponding to the magnetic disc.

Here, in the present embodiment, as described later, this silicon film 28 is used as a mold for forming a stamper, and in the following, the silicon film 28 that has undergone this step of removing particles (step S118) is called a stamper mold 30.

A series of processing from the step of forming a silicon film (step S115) to the step of removing particles (step S118) corresponds to one example of the step of forming a mold according to the present invention; the stamper mold 30 corresponds to one example of the mold according to the present invention; and the concave and convex structure of this stamper mold 30 corresponds to one example of the nano structure according to the present invention. Additionally, a series of processing from the step of forming a particle layer (step S111) to the step of removing particles (step S118) is also regarded as one embodiment of the method of fabricating a nano structure according to the present invention.

After the stamper mold 30 is obtained, the step of obtaining a stamper (step S150) shown as one block in FIG. 5 is executed. In step S150, a stamper 31 is obtained by executing a so-called electroforming processing in which a predetermined metal is adhered to the mold until the metal forms a block shape by means of electrolytic plating and then the mold is peeled off, by using the stamper mold 30 as the mold. Accordingly, this step of obtaining a stamper (step S150) can be repeated several times by using the stamper mold 30, so that the stamper 31 as consumables can be produced in volume. Here, the concave and convex structure of this stamper 31 also corresponds to one example of the nano structure according to the present invention. Furthermore, a series of processing from the step of forming a particle layer (step S111) to the step of obtaining a stamper (step S150) is also regarded as one embodiment of the method of fabricating the nano structure according to the present invention.

Up to this point, the series of processing explained by referring to FIG. 6 to FIG. 7 corresponds to the step of preparing a stamper (step S100) shown as one block in FIG. 4.

Next, the step of manufacturing (step S200) shown as one block in FIG. 4 is explained in detail.

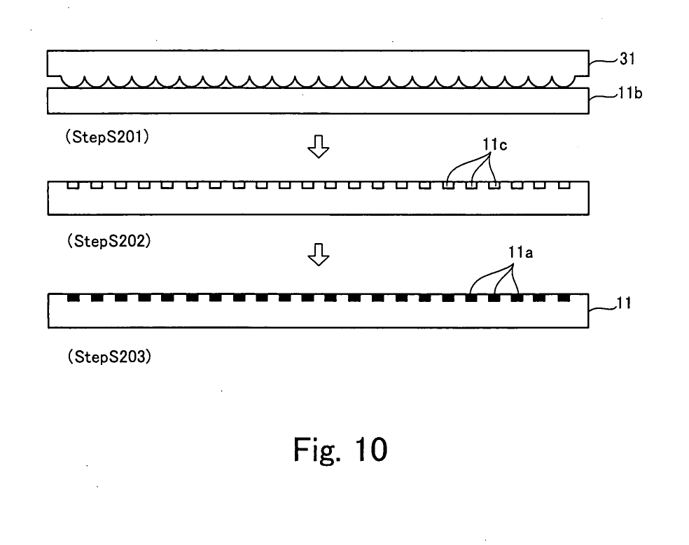

FIG. 10 is a diagram illustrating the details of the step of manufacturing (step S200) in FIG. 4.

In this step of manufacturing (step S200), first of all, the step of pressing (step S201) is executed. In step S201, multiple indentations with a nano-sized array pattern are formed by pressing the stamper 31 prepared in the step of preparing a stamper (step S100) at a high pressure against the surface of an aluminum board 11b having a disc shape that becomes a base of the magnetic disc 11. A series of processing from the step of preparing a stamper (step S100) to this step of pressing (step S201) corresponds to one embodiment of the method of generating a base body according to the present invention.

Thereafter, the step of shaping (step S202) is executed. In step S202, each of the multiple indentations formed in this step of pressing (step S201) is formed into a hole 11c with diameter of 10 to 100 nm using an anodizing process.

Here, a combination of the step of pressing (step S201) and the step of shaping (step S202) corresponds to one example of the step of forming a hole according to the present invention.

Further, the step of filling (step S203) is executed. In step S203, a magnetic metal is filed into the multiple holes 11c obtained in the step of shaping (step S202). This step of filling (step S203) corresponds to one example in the step of filling according to the present invention. In this step of filling (step S203), first of all, the surface of the aluminum board 11b through which the multiple holes 11c are pierced is coated with the magnetic metal. Thereafter, the extra magnetic metal existing in portions other than inside of the holes 11c is removed by a lap polishing method. Thus, the 1 bit region 11a also shown in FIG. 1 is formed, with each of the holes 11c filled with the magnetic metal. And finally, various kinds of posttreatments of which diagrams are omitted here are executed and the magnetic disc 11 is completed.

By repeating these series of processing with the use of the stamper 31, the magnetic disc 11 is produced in volume. Additionally, although the stamper 31 is a consumable item and deteriorates each time the magnetic disc 11 is manufactured as explained above, this stamper 31 can be manufactured in volume by using the stamper mold 30 (See FIG. 7), so that mass production of the magnetic disc 11 can be realized.

As explained above, according to the method of manufacturing a magnetic disc in the present embodiment, firstly, a dense and uniform array pattern of the silica particles 22 can be obtained over a wide area equivalent to the magnetic disc 11. Because of this, the fabrication of the stamper mold 30 having transferred the array of the silica particles 22 over such a wide area is made possible, and further the stamper 31 using the stamper mold 30 and furthermore mass production of the magnetic disc 11 using the stamper 31 is made possible.

So far, the method of manufacturing a magnetic disc starting from the fabrication of a nano structure with nano-sized particles to the manufacturing of the magnetic disc has been explained as one embodiment of the present invention. However, the present invention is not limited to this, and may employ another example in which a nano structure created by using nano-sized particles is fixed to be saved as it is. Hereinafter, further explanation is given for this another example that saves a nano structure. Here, also in this another example, the silica particles 22 are used as the nano-sized particles.

In another example, after the processing equivalent to the series of the processing from the step of forming a particle layer (step S111) to the step of removing the substrate (step S114) shown in FIG. 7, the step of fixing an array is executed in which an array pattern of the silica particles 22, which is a nano-structure created in the processing, is fixed.

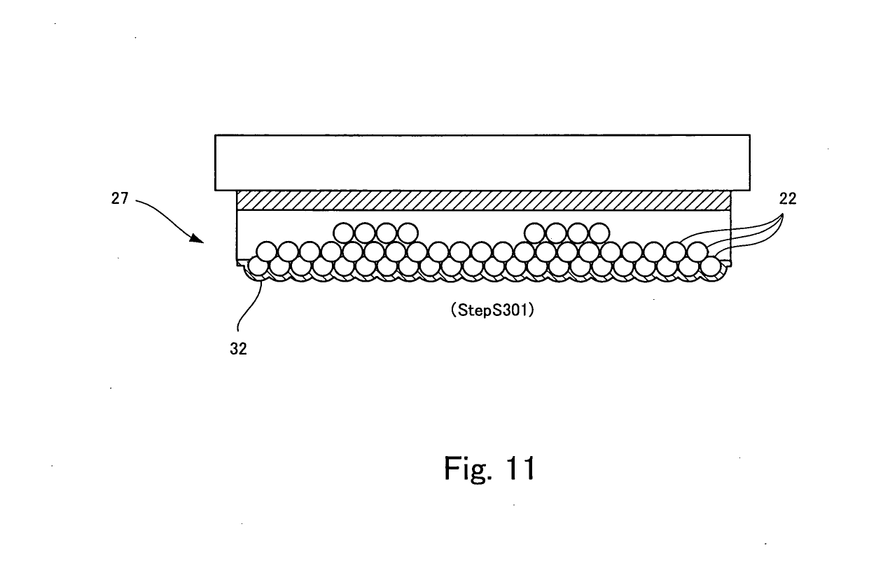

FIG. 11 is a diagram illustrating the step of fixing an array.

First of all, in this FIG. 11, laminated substances composed of the layer of silica particles 22 and the holder 27 obtained by the processing until the step of removing the substrate (step S114) in FIG. 7 is shown.

In the step of fixing an array (step S301) illustrated in this FIG. 11, a metal film 32 made of silicon is formed on the exposed surface of the silica particles 22 by a deposition method. The metal film 32 is so thin that the array pattern on the exposed surface of the layer of the silica particles 22 stands out from the back of the metal film 32. This step of fixing an array (step S301) corresponds to one example of the step of fixing an array according to the present invention. The fragile array pattern of the silica particles 22 can be fixed by the thin metal film 32 formed in this step of fixing an array (step S301). With this, an operation such as mass production of a nano structure is made possible by saving such an array pattern and by transferring the fixed array by a known method such as the above-described electroforming.

In addition, although in the above description, the step of forming a particle layer (step S111) that arranges nanoparticles by using the flow-mediated aggregate method is shown as one example of the step of forming a particle layer according to the present invention, the present invention is not limited to this. The step of forming a particle layer of the present invention may be, for example, one that arranges nanoparticles by using an array method other than the flow-mediated aggregate method that utilizes the self-assembly phenomenon.

Moreover, in the above description, the step of forming a particle layer (step S111) that pulls up the substrate at such a speed that nanoparticles are spread in multiple layers on the substrate by the flow-mediated aggregate method is shown as one example of the step of forming a particle layer according to the present invention. However, the present invention is not limited to this. For example, the one that pulls up the substrate at such a speed that the nanoparticles are spread in a single layer on the substrate by the flow-mediated aggregate method.

In addition, although in the above description, polystyrene particles are shown as one example of the resin particles according to the present invention, the present invention is not limited to this and the one formed of resin particles other than polystyrene may be used.

Furthermore, although in the above description, the method of manufacturing a magnetic disc that prepares a stamper first and then manufactures the magnetic disc by using the stamper is shown as an applied example of the method of fabricating a nano structure of the present invention, the present invention is not limited to this. The method of fabricating a nano structure of the present invention may be applied, for example, to the manufacturing of patterned media other than the magnetic discs, for manufacturing a light guide board having a nonreflective feature through a nano-sized dense concave and convex structure used for a display or the like of mobile phones, or to a high efficiency filter having nano-sized dense holes.

What is claimed is:

1. A method of fabricating a nano structure, comprising the steps of:
forming a particle layer on a substrate that is nano-scale flat by spreading at least one layer of nano-sized particles made of a material different from that of the substrate;
forming a holder on the particle layer, the holder holding the particle layer by closely adhering to particles forming the particle layer; and
removing the substrate in a manner that leaves the particle layer intact.

2. The method of fabricating a nano structure according to claim 1, wherein the step of forming the particle layer is a step of forming the particle layer by immersing the substrate into a suspension of the particles and by pulling up the substrate from the suspension.

3. The method of fabricating a nano structure according to claim 1, wherein the substrate is made of resin and the particles are made of silica, and
the step of removing the substrate is a step of removing the substrate by burning the substrate.

4. The method of fabricating a nano structure according to claim 1, wherein the substrate is made of resin and the particles are made of silica, and
the step of removing the substrate is a step of removing the substrate by dissolving the substrate in an organic solvent.

5. The method of fabricating a nano structure according to claim 1, wherein the substrate is made of glass and the particles are made of resin; and
the step of removing the substrate is a step of removing the substrate by dissolving the substrate in a dilute hydrofluoric acid solution.

6. The method of fabricating a nano structure according to claim 1, wherein the step of forming a holder is a step of forming a metal layer on the particle layer and adhering a block body onto the metal layer.

7. The method of fabricating a nano structure according to claim 1, further comprising the step of fixing an array of particles by forming a metal layer on a surface of the particle layer, the surface of the particle layer being exposed by removing the substrate in the step of removing the substrate.

8. The method of fabricating a nano structure according to claim 1, further comprising the step of fixing an array of particles by forming a metal layer on a surface of the particle layer, the surface of the particle layer being exposed by removing the substrate in the step of removing the substrate, the metal layer so thin that the array of particles on the surface of the particle layer stands out from a back of the metal layer.

9. The method of fabricating a nano structure according to claim 1, further comprising the step of creating a mold by transferring an array of particles on a surface of the particle layer, the surface of the particle layer being exposed by removing the substrate in the step of removing the substrate.

10. The method of fabricating a nano structure according to claim 1, wherein the step of forming a particle layer is a step of forming a particle layer by spreading the particles in a plurality of layers, and
the step of forming a holder is a step of forming a first metal layer on the particle layer and adhering a first block body onto the first metal layer,
the method further comprising the step of creating a mold to which the array of particles is transferred,
wherein the step of creating the mold comprises:
fixing an array of particles by forming a second metal layer on a surface of the particle layer, the surface of the particle layer being exposed by removing the substrate in the step of removing the substrate;
adhering a second block body onto the second metal layer;
separating the first block body and the second block body from each other at the particle layer by applying force to the first block body and the second block body; and
removing particles attached to the second block body by the separation, from among the particles forming the particle layer, in a manner that leaves the second metal layer intact.

11. A method of manufacturing a magnetic disc, comprising the steps of:
forming a particle layer on a substrate that is nano-scale flat by spreading at least one layer of nano-sized particles made of a material different from that of the substrate;
forming a holder on the particle layer, the holder holding the particle layer by closely adhering to the particles forming the particle layer; and
removing the substrate in a manner that leaves the particle layer intact;
creating a mold by transferring an array of particles on a surface of the particle layer, the surface of the particle layer being exposed by removing the substrate in the step of removing the substrate;
forming a plurality of holes with an array that is the same as the array of particles, on a disc made of a nonmagnetic material by using the mold created in the step of creating a mold; and
filling with a magnetic metal each of the plurality of holes formed in the step of forming holes.

12. A method of forming a stamper, comprising the steps of:
immersing a substrate into a suspension of microscopic particles;
pulling up the substrate from the suspension;
forming a first layer on a particle layer formed of the microscopic particles that is formed on the substrate pulled up from the suspension;
separating the particle layer and the first layer from the substrate;
forming a second layer on a surface of the particle layer, the surface having contacted the substrate before the separation;
separating the particle layer and the first layer from the second layer; and
forming a stamper by using the second layer as a mold.

13. A method of generating a base body, comprising the steps of:
immersing a substrate into a suspension of microscopic particles;
pulling up the substrate from the suspension;
forming a first layer on a particle layer formed of the microscopic particles that is formed on the substrate pulled up from the suspension;
separating the particle layer and the first layer from the substrate;
forming a second layer on a surface of the particle layer, the surface having contacted the substrate before the separation;
separating the particle layer and the first layer from the second layer;
forming a stamper by using the second layer as a mold; and
generating a base body in which a pattern is formed by pressing the stamper against a base material.
